(19) United States
(12) Patent Application Publication
(10) Pub. No.: US 2007/0086046 A1
(43) Pub. Date: Apr. 19, 2007

(54) Image forming apparatus and a method for processing printing data

(75) Inventor: Han-sung Kim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/508,321

(22) Filed: Aug. 23, 2006

(30) Foreign Application Priority Data
Oct. 19, 2005 (KR) 2005-98607

(51) Int. Cl. G06K 15/00

(52) U.S. Cl. 358/1.15; 358/1.14

(57) ABSTRACT

An image forming apparatus for receiving and processing printing data includes a data transceiver unit that receives printing data including recipient information from an external client personal computer (PC), a detection unit that detects the recipient information from the printing data, a storage unit, and a control unit that stores the printing data in a memory that corresponds to the recipient information. When a user corresponding to the recipient information is registered, the control unit stores the printing data in a normal memory allocated to the registered user and, when the user is unregistered, the control unit stores the printing data in a temporary memory. The control unit notifies at least one client PC corresponding to the recipient information of the receipt of the printing data through the data transceiver unit. Accordingly, it is possible to accurately transmit the printing data to the intended recipients.

### CROSS-REFERENCE TO RELATED APPLICATIONS

This application claims the benefit under 35 U.S.C. § 119(a) of Korean Patent Application No. 2005-98607, filed Oct. 19, 2005, the entire contents of which are hereby incorporated by reference.

### BACKGROUND OF THE INVENTION

1. Field of the Invention

The present invention relates to an image forming apparatus and a method for processing printing data. More particularly, the present invention relates to an image forming apparatus and a method for receiving printing data assigned to a certain recipient and storing the printing data.

2. Description of the Related Art

As network technology has advanced, networks that connect a plurality of terminal devices together have spread to domestic use as well as business use. In such networks, a plurality of user can share a variety of computer peripherals by connecting the peripherals to the network. One typical example of a peripheral is an image forming apparatus that includes a network interface card to receive printing data through the network.

On a network system that includes the network image forming apparatus, a user may transmit printing data to the image forming apparatus and then notify another user who will share the printing data that the printing data has been transmitted. The image forming apparatus stores and prints the printing data. Accordingly, the other user who has been notified of the transmission of the printing data may pick up the printed document from the image forming apparatus, thereby sharing the printing data.

In a conventional printing network system as described above, however, the printed document may not be delivered to the intended recipient. For example, even if a user is notified that certain printing data has been transmitted, the user also needs to know the details of the printing data to receive the correct printed document. If the recipient is not informed of enough details, the printed document might be delivered to the wrong recipient.

Additionally, if the intended recipient is absent, the intended recipient may not be notified immediately of the transmission of the printing data. Therefore, the printed document may be left unattended at the image forming apparatus. In this case, the transmitter of the printing data may continuously retry contacting the intended recipient. Furthermore, when the printing data is confidential, security concerns may arise if the printed document is left unattended.

Accordingly, there is a need for an improved apparatus and method of managing printing data in an image forming apparatus.

### SUMMARY OF THE INVENTION

An aspect of the present invention is to address at least the above problems and/or disadvantages and to provide at least the advantages described below. Accordingly, an aspect of the present invention is to provide an image forming apparatus which is capable of, upon receiving printing data, storing the printing data to a memory corresponding to recipient information included in the printing data, thereby preserving security, and correctly delivering the printing data to an intended recipient, and a method for processing the printing data.

Another aspect of the present invention is to provide an image forming apparatus which is capable of saving storage space by detecting printing data for unregistered recipients, and frequently erasing such printing data, and a method for processing the printing data.

Yet another aspect of the present invention is to provide an image forming apparatus which is capable of, notifying an intended recipient of the receipt of printing data by notifying a client personal computer (PC) corresponding to the intended recipient when the printing data is received and stored in a predetermined memory.

In accordance with an aspect of the present invention, an image forming apparatus comprising a data transceiver unit, a detection unit, a storage unit, and a control unit. The data transceiver unit receives printing data including recipient information from an external client personal computer (PC). The detection unit detects the recipient information from the printing data. The control unit stores the printing data in a memory corresponding to the recipient information.

When a user corresponding to the recipient information is registered, the control unit may store the printing data in a normal memory allocated to the registered user. When the user is unregistered, the control unit may store the printing data in a temporary memory.

The control unit notifies at least one client PC corresponding to the recipient information of the receipt of the printing data through the data transceiver unit.

The image forming apparatus may further comprise a print unit that prints under the control of the control unit. The control unit may control the print unit upon receiving a printing command related to the printing data to print out the printing data.

The data transceiver unit may communicate with the external client PC or the at least one client PC using a file transfer protocol (FTP).

The control unit may erase the printing data stored in the temporary memory at predetermined intervals.

In accordance with another aspect of the present invention, a method of managing printing data in an image forming apparatus comprises the steps of (a) receiving printing data including recipient information from an external client PC, (b) detecting the recipient information from the printing data, and (c) storing the printing data in a memory corresponding to the recipient information.

The step (c) may comprise the step of determining whether a user corresponding to the recipient information is registered. If the user corresponding to the recipient information is registered, the printing data is stored in a normal memory allocated to the registered user. If the user corresponding to the recipient information is unregistered, the printing data is stored in a temporary memory.

The processing method may further comprise the step of notifying at least one client PC corresponding to the recipient information of the receipt of the printing data. The method may further comprise the step of printing out the printing data upon receipt of a printing command for the printing data.

The step (a) may receive the printing data using a file transfer protocol (FTP).

The step (a) may comprise the steps of receiving a connection request from an external client PC, requesting a user identification (ID) and a password from the external client PC, and, upon receiving the user ID and password from the external client PC, authenticating the user by comparing the received user ID and password with those of a registered user, and receiving the printing data from the external client PC after completing the authentication.

The processing method may further comprise the step of erasing the printing data stored in the temporary memory at predetermined intervals.

In accordance with another aspect of the present invention, a method of processing data in an image forming apparatus comprises the steps of (a) receiving printing data that includes recipient information, (b) detecting the recipient information in the printing data to determine the intended recipient of the printing data, (c) determining whether the intended recipient is a registered user, (d) if the intended recipient is a registered user, storing the printing data in an allocated memory, and (e) if the intended recipient is an unregistered user, storing the printing data in a temporary memory.

The method may further comprise the step of notifying at least one client PC corresponding to the intended recipient of the receipt of the printing data, if the intended recipient is a registered user.

The method may further comprise the step of broadcasting a notice of the receipt of the printing data to a network, if the intended recipient is an unregistered user.

The method may further comprise the step of printing out the printing data upon receiving a printing command for the printing data.

The step (a) may include the:step of authenticating the user.

In accordance with another aspect of the present, invention, an apparatus for managing print data, comprises means for receiving printing data that includes recipient information, means for detecting the recipient information in the printing data to determine the intended recipient of the printing data, means for determining whether the intended recipient is a registered user, means for storing the printing data in an allocated memory, if the intended recipient is a registered user, and means for storing the printing data in a temporary memory, if the intended recipient is an unregistered user.

The apparatus may further comprise means for notifying at least one client PC corresponding to the intended recipient of the receipt of the printing data, if the intended recipient is a registered user.

The apparatus may further comprise means for broadcasting a notice of the receipt of the printing data to a network, if the intended recipient is an unregistered user.

The apparatus may further comprise means for printing out the printing data upon receiving a printing command for the printing data.

The apparatus may further comprise means for authenticating the user.

### BRIEF DESCRIPTION OF THE DRAWING FIGURES

The above and other objects, features, and advantages of certain exemplary embodiments of the present invention will be more apparent from the following description taken in conjunction with the accompanying drawings, in which:

FIG. 1 is a block diagram of the structure of an image forming apparatus according to an exemplary embodiment of the present invention;

FIG. 2 is a block diagram of the structure of a printing network system including the image forming apparatus of FIG. 1;

FIG. 3 is a flowchart of a method for processing printing data in an image forming apparatus according to an exemplary embodiment of the present invention;

FIG. 4 is a flowchart of a method for processing printing data in an image forming apparatus according to another exemplary embodiment of the present invention; and

FIG. 5 is a flowchart of a method for processing printing data in the printing network system of FIG. 2.

Throughout the drawings, the same reference numerals will be understood to refer to the same elements, features, and structures.

### DETAILED DESCRIPTION OF THE EXEMPLARY EMBODIMENTS

The matters defined in the description such as a detailed construction and elements are provided to assist in a comprehensive understanding of the exemplary embodiments of the invention and are merely exemplary. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

Hereinafter, certain exemplary embodiments of the present invention will be described in detail with reference to the accompanying drawing figures.

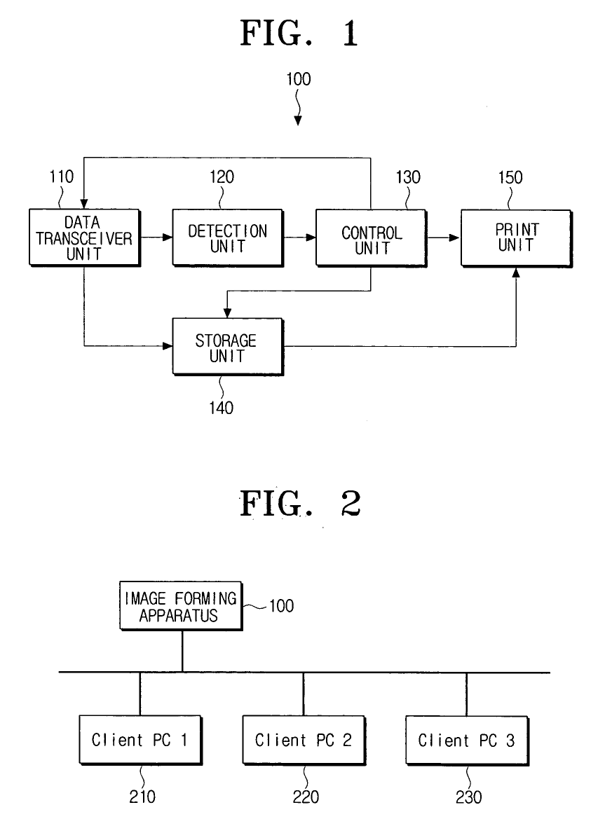

FIG. 1 is a block diagram of the structure of an image forming apparatus according to an exemplary embodiment of the present invention. Referring to FIG. 1, the image forming apparatus 100 comprises a data transceiver unit 110, a detection unit 120, a control unit 130, a storage unit 140, and a print unit 150.

The data transceiver unit 110 communicates with other various terminal devices in accordance with a predetermined protocol. More specifically, the data transceiver unit 110 may open a file transfer protocol (FTP) session with an external client personal computer (PC), and receive printing data through the FTP session. The external client PC may be a terminal device such as a PC, a laptop computer, or a personal digital assistant (PDA) operated by a user. When receiving an FTP connection request packet in addition to the printing data, the data transceiver unit 110 may transmit a request packet to request a user identification (ID) or a password. This will be described in greater detail later.

The detection unit 120 detects recipient information included in the printing data, for example, an FTP server account, a PC ID, or an Internet protocol (IP) address. The recipient information may be input when the user selects a printing option through the PC.

The control unit 130 checks the recipient information detected by the detection unit 120 to determine whether the recipient corresponding to the detected information has been registered. According to the result of determination, the control unit 130 stores the printing data in a corresponding memory of the storage unit 140.

For this, the storage unit 140 includes normal memory and temporary memory. The normal memory is allocated to registered users. The storage unit 140 may be implemented by a mass storage space such as a hard-disc memory.

When it is determined that the detected recipient information is information regarding a registered recipient, the control unit 130 stores the printing data in the normal memory allocated to the recipient. In contrast, if the recipient is unregistered, the control unit 130 stores the printing data in the temporary memory. According to this, the printing data is not printed out to a document until a printing command is separately input by the recipient. Consequently, the security of the printed document can be preserved.

In this case, the control unit 130 may erase the printing data stored in the temporary memory at predetermined intervals. For example, printing data that has been stored for 1˜2 days may be automatically erased. On the other hand, the printing data being stored in the normal memory allocated to user accounts may be saved permanently until a user intentionally erases the printing data, or may be saved relatively longer than the printing data saved in the temporary memory. This prevents waste of the storage unit 140.

After storing the printing data, the control unit 130 may notify at least one client PC corresponding to the recipient information of the reception of the printing data. Such notification can be performed through a simple network management protocol (SNMP) trap method. More particularly, after the printing data is stored, a notification message indicating the receipt of the printing data is sent to the corresponding client PC without having to input a specific command from the external client PC. The message may include the name of the printing data, the name or the account name of the user who sent the printing data, the date of reception of the printing data, or the size of the printing data. The message is transmitted to the respective recipients through the data transceiver unit 110.

Information regarding the client PC that corresponds to the recipient information can be obtained by referring to user information stored in a database in the image forming apparatus 100.

When printing data is transmitted to an unregistered recipient, the reception of the printing data is broadcast throughout the whole network. Accordingly, each recipient is able to notice the transmission of the printing data although the user does not specifically notify each recipient of the transmission of the printing data.

When a printing command with respect to printing data is input through the data transceiver unit 110 or by selecting a printing button disposed on the image forming apparatus 100, the control unit 130 controls the print unit 150 to print out the corresponding printing data.

The print unit 150 performs printing work under the control of the control unit 130. In a laser-type image forming apparatus 100, for example, the print unit 150 may comprise an electrifying unit, a developing unit, a photoconductive medium, a laser scan unit, a transfer unit, and a fixing unit. Since the component parts of the print unit 150 are generally known to those skilled in the art, a detailed description will be omitted for clarity and conciseness.

FIG. 2 is a block diagram of the structure of a printing network system including the image forming apparatus of FIG. 1. Referring to FIG. 2, the printing network system comprises the image forming apparatus 100, and first to third client PCs 210, 220, and 230. Although three client PCs 210, 220 and 230 are shown in FIG. 2, the number of the client PCs and the image forming apparatuses is not limited to this number, and any number can be used.

Prior to preparing a document to be printed, a user of the first client PC 210 enters the information on a recipient to whom the document is directed by selecting a printing option on the printing network system. When the document to be printed is prepared, a printer driver provided in the first client PC 210 converts the document data into a print language interpretable by the image forming apparatus 100, thereby generating printing data. Thus, the generated printing data includes recipient information. The recipient information may be recorded at a header of the printing data.

The printing data is transmitted to the image forming apparatus 100. Before transmitting the printing data, the first client PC 210 needs to connect to the image forming apparatus 100. When the first client PC 210 requests connection to the image forming apparatus 100, the image forming apparatus 100 may request a user ID and password from the first client PC 210. When a user ID and the password are input through the first client PC 210, the image forming apparatus 100 authenticates the user by comparing the user ID and password with those of the registered user. After authentication, the printing data is transmitted from the first client PC 210 to the image forming apparatus 100. The image forming apparatus 100 checks the recipient information included in the printing data and stores the printing data in the memory.

Assuming that, on the printing network system of FIG. 2, the, user account of the second client PC 220 is already registered, and the first client PC 210 transmitted the printing data designating the second client PC 220 as the recipient, the image forming apparatus 100 stores the printing data in the normal memory allocated to the second client PC 220 and then notifies the second client PC 220 of the reception of the printing data. When the user of the second client PC 220 inputs the printing command in response to the notification, the image forming apparatus 100 reads the printing data from the memory and prints the printing data out.

In this case, the user of the second client PC 220 may input the printing command by using a dedicated management program or by selecting a printing button at the image forming apparatus 100.

Assuming that, on the printing network system of FIG. 2, the user account of the third client PC 230 is unregistered and the first client PC 210 transmitted the printing data designating the third client PC 230 as the recipient, the image forming apparatus 100 stores the printing data in the temporary memory and then broadcasts the reception of the printing data to the whole network. The user of the third client PC 230 receives the broadcast message, thereby noticing the receipt of the printing data, and prints out the printing data stored in the temporary memory of the image forming apparatus 100.

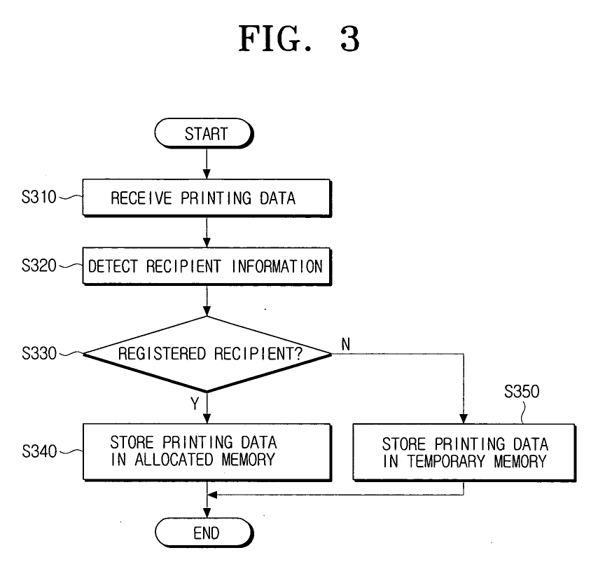

FIG. 3 is a flowchart of a method for processing printing data in an image forming apparatus according to an exemplary embodiment of the present invention. Referring to FIG. 3, when the printing data is received (S310), the image forming apparatus 100 detects the recipient information included in the printing data (S320). As previously discussed, the recipient information may comprise information such as a user account, a user ID, a PC ID, or an IP address.

Next, it is determined whether the detected recipient is a registered user (S330). If so, the printing data is stored in the normal memory allocated to the corresponding recipient (S340). If, however, the recipient is unregistered, the printing data is stored in the temporary memory (S350).

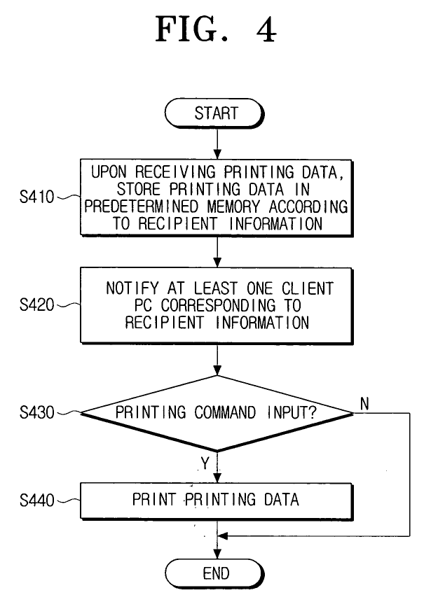

FIG. 4 is a flowchart of a method for processing printing data in an image forming apparatus according to another exemplary embodiment of the present invention. Referring to FIG. 4, when the printing data is, received and the recipient information is detected, the printing data is stored in the memory corresponding to the detected recipient information (S410). After the printing data is stored, the image forming apparatus 100 notifies at least one client PC corresponding to the detected recipient information of printing of the printing data (S420).

If a printing command is input within a predetermined time interval (S430), the corresponding printing data is printed out (S440). Here, the printing command may be transmitted from the respective client PCs or may be input through an input means provided at the image forming apparatus 100.

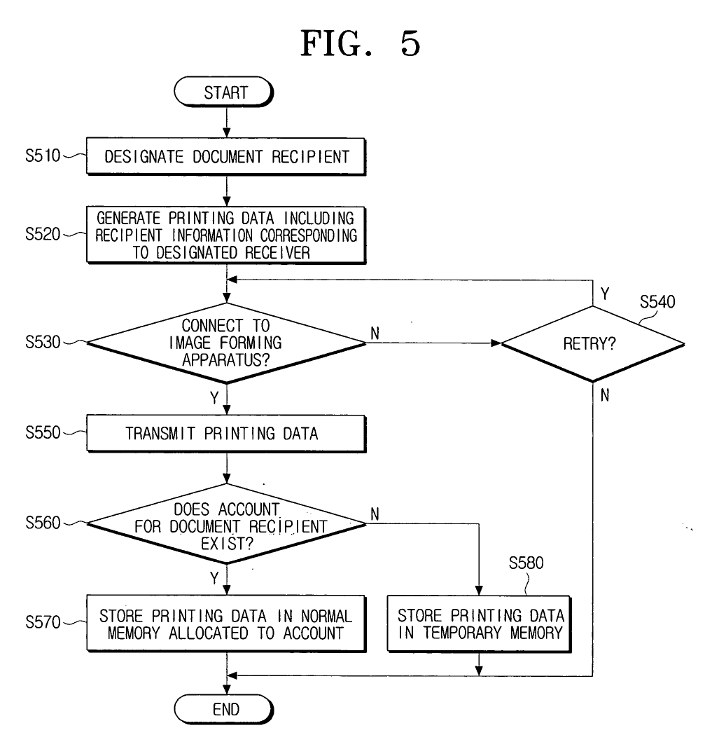

FIG. 5 is a flowchart of a method for processing printing data in a printing network system according to an exemplary embodiment of the present invention. Referring to FIG. 5, the transmitter of the document executes a printer driver program provided in his/her terminal device and designates the recipient of the document by setting a printing option (S510). The document to be printed is thus prepared, and the printing data including recipient information is generated (S520).

In this state, a connection, such as an FTP connection, is requested of the image forming apparatus 100 (S530). More specifically, when a packet requesting a connection is transmitted, the image forming apparatus 100 requests the user ID and the password in response to the request packet. When the user ID and the password are correctly input and transmitted to the image forming apparatus 100, the image forming apparatus 100 authenticates the user, thereby completing the connection. When the wrong user ID and password are input, a connection is not established. In this case, the input of a user ID and password for authentication may be retried a limited number of times (S540), if desired.

When the connection is completed, the printing data is transmitted from the terminal device of the document transmitter to the image forming apparatus 100 (S550).

The image forming apparatus 100 detects the recipient information from the received printing data, and determines whether an FTP account corresponding to the detected recipient information exists (S560). If an FTP account exists, the image forming apparatus stores the printing data in the normal memory allocated to the corresponding account (S570). In contrast, if an FTP account does not exist, the image forming apparatus 100 stores the printing data in the temporary memory (S580).

The image forming apparatus 100 preferably notifies the client PCs that correspond to the recipient information of the; receipt of the printing data, so that the respective recipients may print out the printing data.

The image forming apparatus 100 periodically checks the storage time of the printing data, so as to erase the printing data that has been stored for a predetermined time. In this case, the storage time with respect to the temporary memories may be set shorter than that with respect to the normal memories allocated to the respective recipient accounts.

As described above, according to an exemplary embodiment of the present invention, the printing data can be managed by using recipient information included in the printing data. Consequently, the memory space is guaranteed, the printing data can be prevented from being delivered to a wrong recipient and in addition, security can be guaranteed. Also, delivery of the document can be facilitated by automatically notifying the respective recipients of the receipt of the printing data.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An image forming apparatus comprising:
a data transceiver unit that receives printing data including recipient information from an external client personal computer (PC);
a detection unit that detects the recipient information from the printing data;
a storage unit; and
a control unit that stores the printing data in a memory of the storage unit that corresponds to the recipient information.

2. The image forming apparatus of claim 1, wherein, if a user corresponding to the recipient information is registered, the control unit stores the printing data in a normal memory allocated to the registered user and, if the user is unregistered, the control unit stores the printing data in a temporary memory.

3. The image forming apparatus of claim 2, wherein the control unit notifies at least one client PC that corresponds to the recipient information of the receipt of the printing data.

4. The image forming apparatus of claim 3, further comprising a print unit that performs printing work under the control of the control unit,
wherein the control unit controls the print unit upon receiving a printing command related to the printing data, thereby printing out the printing data.

5. The image forming apparatus of claim 4, wherein the control unit erases the printing data stored in the temporary memory at predetermined intervals.

6. The image forming apparatus of claim 5, wherein the data transceiver unit communicates with the external client PC or the at least one client PC with file transfer protocol (FTP).

7. The image forming apparatus of claim 1, wherein the recipient information comprises at least one of a user account, a user ID, a PC ID, or an IP address.

8. A method of processing printing data apparatus, comprising
(a) receiving printing data including recipient information from an external client PC;
(b) detecting the recipient information from the printing data; and
(c) storing the printing data in a memory corresponding to the recipient information.

9. The method of claim 8, wherein the step (c) comprises
determining whether a user corresponding to the recipient information is registered;
if the user corresponding to the recipient information is registered, storing the printing data in a normal memory allocated to the registered user; and
if the user corresponding to the recipient information is unregistered, storing the printing data in a temporary memory.

10. The method of claim 9, further comprising
notifying at least one client PC corresponding to the recipient information of the receipt of the printing data.

11. The method of claim 10, further comprising printing out the printing data upon receiving a printing command for the printing data.

12. The method of claim 9, further comprising erasing the printing data stored in the temporary memory at predetermined intervals.

13. The processing method of claim 9, wherein the step (a) comprises receiving the printing data using file transfer protocol (FTP).

14. The processing method of claim 9, wherein the step (a) comprises the steps of:
receiving a connection request from the external client PC;
requesting user identification (ID) and password from the external client PC;
upon receiving the user ID and password from the external client PC, authenticating the user by comparing the received user ID and password with those of a registered user; and
receiving the printing data from the external client PC after completing the authentication.

15. The processing method of claim 9, wherein the recipient information comprises at least one of a user account, a user ID, a PC ID, or an IP address.

16. A method of processing data in an image forming apparatus, comprising the steps of:
(a) receiving printing data that includes recipient information;
(b) detecting the recipient information in the printing data to determine the intended recipient of the printing data;
(c) determining whether the intended recipient is a registered user;
(d) if the intended recipient is a registered user, storing the printing data in an allocated memory; and
(e) if the intended recipient is an unregistered user, storing the printing data in a temporary memory.

17. The method of claim 16, further comprising notifying at least one client PC corresponding to the intended recipient of the receipt of the printing data, if the intended recipient is a registered user.

18. The method of claim 17, further comprising broadcasting a notice of the receipt of the printing data to a network, if the intended recipient is an unregistered user.

19. The method of claim 18, further comprising printing out the printing data upon receiving a printing command for the printing data.

20. The method of claim 16, wherein the step (a) includes the step of authenticating the user.

21. The method of claim 16, wherein the recipient information comprises at least one of a user account, a user ID, a PC ID, or an IP address.

22. An apparatus for managing print data, comprising:
means for receiving printing data that includes recipient information;
means for detecting the recipient information in the printing data to determine the intended recipient of the printing data;
means for determining whether the intended recipient is a registered user;
means for storing the printing data in an allocated memory, if the intended recipient is a registered user; and
means for storing the printing data in a temporary memory, if the intended recipient is an unregistered user.

23. The apparatus of claim 22, further comprising means for notifying at least one client PC corresponding to the intended recipient of the receipt of the printing data, if the intended recipient is a registered user.

24. The apparatus of claim 23, further comprising means for broadcasting a notice of the receipt of the printing data to a network, if the intended recipient is an unregistered user.

25. The apparatus of claim 24, further comprising means for printing out the printing data upon receiving a printing command for the printing data.

26. The apparatus of claim 22, further comprising means for authenticating the user.

27. The apparatus of claim 22, wherein the recipient information comprises at least one of a user account, a user ID, a PC ID, or an IP address.
